(19) United States
(12) Patent Application Publication
(10) Pub. No.: US 2022/0024691 A1
(43) Pub. Date: Jan. 27, 2022

(54) ARTICLE SORTING SYSTEM AND METHOD

(71) Applicant: Tompkins Robotics, Inc., Raleigh, NC (US)

(72) Inventors: James M. Serstad, Orlando, FL (US); Michael C. Futch, Orlando, FL (US)

(21) Appl. No.: 17/366,369

(22) Filed: Jul. 2, 2021

Related U.S. Application Data
(63) Continuation of application No. PCT/US21/40234, filed on Jul. 2, 2021.
(60) Provisional application No. 63/055,515, filed on Jul. 23, 2020.

(51) Int. Cl. B65G 1/137; B65G 1/04; B66F 9/06; G06Q 10/06; G06Q 50/28; G05B 15/02

(52) U.S. Cl. CPC B65G 1/1373; B65G 1/0492; B66F 9/063; G06K 7/1413; G06Q 50/28; G06Q 10/06395; G05B 15/02; G06Q 10/06315

(57) ABSTRACT

Control system for sorting receives a first order and assigns a first destination container of a plurality of destination containers to the first order to direct a computer-controlled mobile transport device to deposit a first and a second article into the destination container based on a product type of each article. The first and second articles are selected from the plurality of disparate articles. The first and second articles from the article supply location are both deposited at a same instant onto the computer-controlled mobile transport device. The control system directs the computer-controlled mobile transport device to transport and deposit both the first and second articles in the destination container in a single trip by manipulation of the computer-controlled mobile transport device from a first position to a second position. The control system determines when the order has been completed and directs removal of the completed order.

### CROSS-REFERENCE TO RELATED APPLICATIONS

This application is a continuation of International Application No. PCT/US2021/040234 filed on Jul. 2, 2021, which claims priority to U.S. Provisional Patent Application No. 63/055,515 filed on Jul. 23, 2020, the entire contents of which are incorporated by reference herein.

### TECHNICAL FIELD

The present invention relates to sorting technology, and specifically to an article sorting system and method.

### BACKGROUND

Article sorting includes dispensing items going to different destinations to different exits through a delivery device in a manner that realizes subsequent transport of items and packages going to the different destinations in a resource-effective manner. This is especially advantageous in an order fulfillment center or a shipping facility. Generally, an article or a parcel containing articles for shipment will have a UPC, barcode, SKU, or similar that allows for identification of the article and its destination. Article sorting includes dispensing articles that come from a plurality of locations to different exits through a delivery device to realize unified consolidation at a single exit or destination point whether a given order includes a single article or is in the form of an order, a parcel, a carton, a tote, etcetera containing two or more articles. This is especially advantageous in any type of article or parcel fulfillment center. However, the order fulfillment process can be quite labor intensive, which increases cost, introduces errors in processing, and increases the time for the order items to reach the ultimate customer—all lessening the end customer experience. Additionally, order items may be damaged, mispackaged, and the like, reducing efficiency for all involved parties.

Automated sorting equipment may be useful for addressing these issues. However, automated sorting equipment can be expensive, require significant capital investment, take up large portions of warehouse space, be limited in the item size that it can sort, be significantly underutilized during off-peak periods, and have long payback on the investment made in most cases.

Accordingly, opportunities exist for provision of an improved system and method that overcomes the limitations of the art.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

According to one or more embodiments, a system for sorting articles to one or more destinations includes an article supply location, wherein the article supply location includes a plurality of articles to be sorted. The system further includes a first computer-controlled mobile transport device having a first position in which an article is stowed about the device and a second position in which the article is deposited into a proximal destination container. The system also includes a platform elevated from a first surface, wherein the first computer-controlled mobile transport device traverses the platform, and the stowed articles are deposited into a destination container positioned proximal the platform. The system also includes a control system. The control system is configured to receive a first order for a plurality of disparate articles found within the article supply location. The control system assigns a first destination container of a plurality of destination containers to the first order to direct the first computer-controlled mobile transport device to deposit a first article and a second article into the first destination container based on a product type of each article, the first and second articles selected from the plurality of disparate articles, wherein the first and second articles from the article supply location are both deposited at a same instant onto the first computer-controlled mobile transport device. The control system directs the first computer-controlled mobile transport device to transport and deposit both the first and second articles in the first destination container in a single trip by manipulation of the first computer-controlled mobile transport device from the first position to the second position. The control system determines the first order has been completed.

According to one or more embodiments, the control system is configured to receive a second order for a plurality of disparate articles found within the article supply location; assign a second destination container of the plurality of destination containers to the second order to direct a second computer-controlled mobile transport device to deposit a third article and a fourth article into the second destination container based on a product type of each article, the third and fourth articles selected from the plurality of disparate articles, wherein the third and fourth articles from the article supply location are both deposited at a same instant onto the second computer-controlled mobile transport device. The second computer-controlled mobile transport device has a first position in which an article is stowed about the device and a second position in which the article is deposited into a proximal destination container. The second computer-controlled mobile transport device traverses the platform. The control system is further configured to direct the second computer-controlled mobile transport device to transport and deposit both the third and fourth articles in the second destination container in a single trip by manipulation of the second computer-controlled mobile transport device from the first position to the second position. The system determines when the second order has been completed.

According to at least one embodiment, the control system directs the second computer-controlled mobile transport device to transport and deposit both the third and fourth articles in the first destination container in a single trip by manipulation of the second computer-controlled mobile transport device from the first position to the second position.

A system for sorting articles to one or more destinations comprises an article supply location, wherein the article supply location includes a plurality of articles to be sorted. The system includes a first computer-controlled mobile transport device having a first position in which an article is stowed about the device and a second position in which the article is deposited into a proximal destination container. A platform is elevated from a first surface, wherein the first computer-controlled mobile transport device traverses the platform, and the stowed articles are deposited into a destination container positioned proximal the platform; and a control system. The control system is configured to receive a first order for a plurality of disparate articles found within the article supply location and assign a first destination container of a plurality of destination containers to the first order to direct the first computer-controlled mobile transport device to deposit a first article and a second article into the first destination container based on a product type of each article. The first and second articles selected from the plurality of disparate articles. The first and second articles from the article supply location are both deposited at a same instant onto the first computer-controlled mobile transport device. The system further directs the first computer-controlled mobile transport device to transport and deposit both the first and second articles in the first destination container in a single trip by manipulation of the first computer-controlled mobile transport device from the first position to the second position. The system determines when the first order has been completed. The system receives a second order for a plurality of disparate articles found within the article supply location. The system assigns a second destination container of the plurality of destination containers to the second order to direct a second computer-controlled mobile transport device to deposit a third article and a fourth article into the second destination container based on a product type of each article. The third and fourth articles are selected from the plurality of disparate articles, wherein the third and fourth articles from the article supply location are both deposited at a same instant onto the second computer-controlled mobile transport device. The second computer-controlled mobile transport device has a first position in which an article is stowed about the device and a second position in which the article is deposited into a proximal destination container. The second computer-controlled mobile transport device traverses the platform. The system directs the second computer-controlled mobile transport device to transport and deposit both the third and fourth articles in the second destination container in a single trip by manipulation of the second computer-controlled mobile transport device from the first position to the second position. The system further determines when the second order has been completed.

A system for sorting articles to one or more destinations comprises an article supply location, wherein the article supply location includes a plurality of articles to be sorted. The system includes a first computer-controlled mobile transport device having a first position in which an article is stowed about the device and a second position in which the article is deposited into a proximal destination container. A platform elevated from a first surface, wherein the first computer-controlled mobile transport device traverses the platform, and the stowed articles are deposited into a destination container positioned proximal the platform. The system further includes a control system. The control system is configured to receive a first order for a plurality of disparate articles found within the article supply location. The control system assigns a first destination container of a plurality of destination containers to the first order to direct the first computer-controlled mobile transport device to deposit a first article and a second article into the first destination container based on a product type of each article. The first and second articles are selected from the plurality of disparate articles. The first and second articles from the article supply location are both deposited at a same instant onto the first computer-controlled mobile transport device. The control system directs the first computer-controlled mobile transport device to transport and deposit both the first and second articles in the first destination container in a single trip by manipulation of the first computer-controlled mobile transport device from the first position to the second position. The control system determines when the first order has been completed. The control system directs removal of the first destination container for shipment processing and directs placement of a replacement destination container at a location of the removed first destination container; or directs removal of all articles in the first destination container for shipment processing and assign a third order to the first destination container.

A control system configured for use with sorting of a plurality of disparate articles is provided. The control system includes a memory and a processor. The control system is configured to receive a first order for a plurality of disparate articles found within an article supply location and assign a first destination container of a plurality of destination containers to the first order to direct a first computer-controlled mobile transport device to deposit a first and a second article into the first destination container based on a product type of each article. The first and second articles are selected from the plurality of disparate articles, wherein the first and second articles from the article supply location are both deposited at a same instant onto the first computer-controlled mobile transport device. The control system is further configured to direct the first computer-controlled mobile transport device to transport and deposit both the first and second articles in the first destination container in a single trip by manipulation of the first computer-controlled mobile transport device from a first position to a second position. The control system is also configured to determine the first order has been completed.

### BRIEF DESCRIPTION OF THE DRAWINGS

In order to describe the technical solutions of the examples of the present invention more clearly, the figures required to be used for the examples will be briefly introduced below. It should be understood that the following figures only show some examples of the present invention, and thus shall not be construed as limiting the scope thereof; and for a person skilled in the art, further relevant figures could also be obtained according to the figures without using inventive efforts.

FIG. 1 shows a structural schematic diagram of a sorting system provided in Example 1 of the present invention in accordance with some embodiments of the presently disclosed subject matter.

FIG. 2 shows a system chart of the sorting system provided in Example 1 of the present invention in accordance with some embodiments of the presently disclosed subject matter.

FIG. 3 shows a system chart of another sorting system provided in Example 1 of the present invention in accordance with some embodiments of the presently disclosed subject matter.

FIG. 4 shows a structural schematic diagram of another sorting system provided in Example 1 of the present invention in accordance with some embodiments of the presently disclosed subject matter.

FIG. 5 shows a schematic structural diagram of a platform with a highway and fingers layout in accordance with some embodiments of the presently disclosed subject matter.

FIG. 6 shows an illustration of an embodiment a sorting system in accordance with some embodiments of the presently disclosed subject matter.

FIG. 7 shows a schematic structural diagram of a platform with two panels forming part of a sorting system in accordance with some embodiments of the presently disclosed subject matter.

FIG. 8 shows a schematic structural diagram of a platform with two panels forming part of a sorting system in accordance with some embodiments of the presently disclosed subject matter.

FIG. 9 shows a chart of a sorting system in accordance with some embodiments of the presently disclosed subject matter.

### DETAILED DESCRIPTION OF THE EMBODIMENTS

Below, the technical solutions in the examples of the present invention are depicted clearly and comprehensively with reference to the figures according to the examples of the present invention. Obviously, the examples depicted here are merely some examples, but not all examples of the present invention. In general, the components in the examples of the present invention depicted and shown in the figures herein can be arranged and designed according to different configurations. Thus, detailed description of the examples of the present invention provided in the figures below are not intended to limit the scope of the present invention as claimed, but merely represent selected examples of the present invention. On the basis of the examples of the present invention, all of other examples that could be obtained by a person skilled in the art without using inventive efforts will fall within the scope of protection of the present invention.

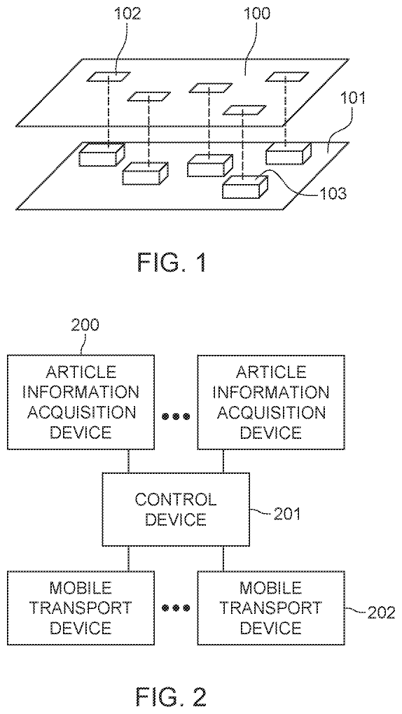

As Example 1, in order to solve the problem existing in the prior art that the article sorting efficiency needs to be increased, as shown in FIG. 1, an example of the present invention provides an article sorting system. The article sorting system includes an article sorting device 100 and an article collecting device 101. The article sorting device 100 is provided thereon with a plurality of article checking inlets 104 and a plurality of article outlets 102, and the article collecting device 101 is located just below the article sorting device 100. The plurality of article outlets 102 on the article sorting device 100 are respectively in communication or connected with the article collecting device 101. The plurality of article outlets 102 are respectively located at the middle or/and edges of the or throughout the article sorting device 100. The article collecting device 101 is provided thereon with storage devices 103, with one storage device located at each of positions of the article outlets. In one embodiment, an opening diameter of the storage device 103 is greater than a diameter of the article outlet 102. It is to be noted that while various aspects of the presently disclosed subject matter are being described herein with respect to sorting of an article, embodiments of the presently disclosed subject matter nonetheless equally apply to a parcel containing two or more articles. The disclosed provided herein accordingly equally applies to sorting of articles as well as to parcels containing two or more articles.

Article sorting device 100 and the article collecting device 101 are embodied in many structures, e.g., quadrangle, circle, polygon and so on, and the article collecting device 101. In one embodiment, article sorting device 100 has substantially the same area. In order to improve the article sorting efficiency, preferably, each of the article checking inlets 104 is provided with one or more article information acquisition devices 200. The article checking inlets 104 are in one-to-one correspondence with the article information acquisition devices 200, the article information acquisition devices 200 are configured to acquire article information of the articles to be sorted that enter the article checking inlets 104 corresponding to the article information acquisition devices 200. The article information contains destinations of the articles to be sorted. A plurality of article checking inlets 104 are provided. Each article checking inlet 104 is provided with an article information acquisition device 200, such that the information acquisition and sorting of the plurality of articles to be sorted may be performed simultaneously at the plurality of article checking inlets 104, to significantly increase the article information acquisition efficiency, thereby improving the article sorting efficiency.

In the above, there are many manners for the article information acquisition devices 200 to acquire the article information of the articles to be sorted. Preferably, the destination information is carried in a destination address information code, the destination address information code is provided on the article to be sorted, each of the article information acquisition devices 200 includes a scanner. The scanner is configured to scan the information code for obtaining the destination of the article to be sorted. For example, the articles to be sorted are provided thereon with information codes containing destination information of the articles to be sorted, and the article information acquisition devices 200 obtain the destinations of the articles to be sorted by scanning the information codes on the articles to be sorted. The information code may be a bar code, a two-dimensional code, a radio frequency tag etc., and correspondingly, the article information acquisition device 200 may be a bar code scanner, a two-dimensional code scanner, a radio frequency identifier, etc. According to actual demands, in addition to the destination, the article information may further contain information about the article volume, weight etc., and correspondingly, the article information acquisition device 200 may further include a weighing device, a volume scanner, etc.

While the article information is highly-efficiently obtained, in order to improve the efficiency of subsequent sorting, preferably, after the plurality of article information acquisition devices 200 simultaneously acquire the article information of the respective articles to be sorted, the control system 201 is used to complete the analytical processing of the obtained article information of all the articles to be sorted, thereby obtaining the destination information of the respective articles to be sorted. For example, the system can further include a control system 201. Control system 201 is in connection with all the article information acquisition devices 200 so as to obtain the article information acquired by all the article information acquisition devices 200 and further obtain the destinations of the respective articles to be sorted.

After obtaining the article information, in order to improve the efficiency of the subsequent sorting processes, the system can further include a plurality of mobile transport devices 202, wherein the plurality of mobile transport devices 202 are in connection with the control system 201, control system 201 is pre-provided with article outlets 102 respectively corresponding to different destinations. Control system 201 is further configured to control, according to the obtained destinations of the articles to be sorted, at least one of the mobile transport devices 202 to transport the articles to be sorted to article outlets 102 corresponding to the destinations of the articles to be sorted, as shown in FIG. 2. Each mobile transport device 202 may be an auto-navigating small vehicle.

In the above, the control system 201 has already obtained the destinations of the respective articles to be sorted at the respective article checking inlets 104, and in at least one embodiment, the article sorting can be completed just by obtaining the transport paths of the respective articles to be sorted through analysis according to the positions of the article outlets 102 corresponding to the destinations of the respective articles to be sorted, and then controlling at least one of the mobile transport devices 202 to transport, according to the transport paths, each of the articles to be sorted to the article outlets 102 corresponding to the destinations of the articles to be sorted. The analysis by the control system 201 on the transport paths of the respective articles to be sorted is performed simultaneously. After the path analysis is completed, the plurality of mobile transport devices 202 may be simultaneously controlled, to simultaneously complete transporting of the individual articles to be sorted, thereby significantly improving the article sorting efficiency.

Each of the mobile transport devices 202 is configured to load one article to be sorted or a plurality of articles to be sorted that go to the same destination. In one embodiment, mobile transport device 202 is configured to transport one article to be sorted one time, and the control system 201 sends a control instruction to the mobile transport device 202 after obtaining the destination of the article to be sorted that is going to be transported by the mobile transport device 202, such that the mobile transport device 202 travels to the position of the article outlet 102 corresponding to the destination of the article to be sorted.

In one embodiment, the articles to be sorted may be manually loaded onto mobile transport devices 202. The articles to be sorted may also be automatically loaded onto mobile transport devices 202 by intelligently controlling article gripping devices or the like through control system 201. Similarly, the transport of the articles to be sorted from article outlets 102 to article collecting device 101 can be performed manually and may also be completed by intelligently controlling article gripping devices or the like through control system 201.

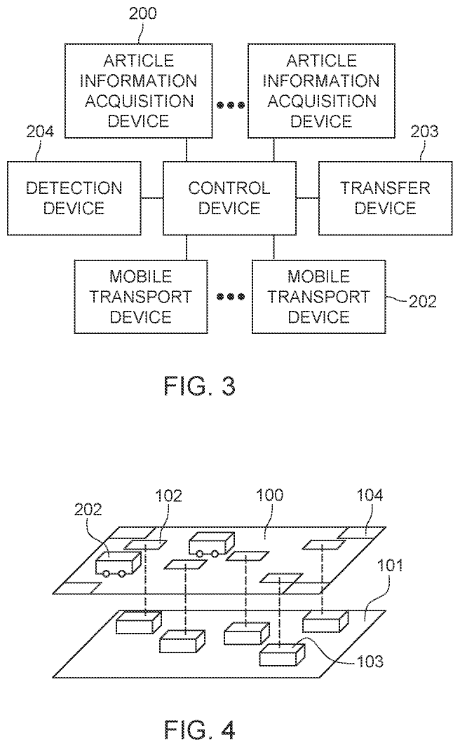

In order to assure that the respective articles to be sorted that are transported into the article collecting device 101 can be delivered to its ultimate destination, the system preferably further includes a detection device 204 and a transfer device 203, wherein the detection device 204 is configured to detect whether a storage device 103 is full or not and to transmit to control system 201 the obtained information regarding whether storage device 103 is full or not, and the transfer device 203 is configured to transfer the storage device 103 which is full according to an instruction from control system 201. There are many options for the transfer device 203, e.g., an intelligent robot; and for another example, storage device 103 is mounted on transfer device 203, and the transfer device 203 is a large-scale auto-navigating vehicle and may move to a position and load and unload the articles according to the control instruction of control system 201, as shown in FIGS. 3 and 4.

Based on the above-mentioned system architecture, the examples of the present invention are implemented as follows. Mobile transport devices, such as a forklift, transport the articles to be sorted to the respective article checking inlets 104. The mobile transport devices can also represent conveyors, AMRs, large goods-to-person systems such as ASRS or shuttle systems, etc. Article information acquisition devices 200 at the respective article checking inlets 104 acquire the article information of the respective articles and transmit the acquired article information to control system 201. Control system 201 performs simultaneous analysis on the article information of the plurality of articles to be sorted to obtain the destinations of the respective articles to be sorted and the article outlets 102 corresponding to the respective destinations and controls the plurality of mobile transport devices 202 to simultaneously transport the respective articles to be sorted to the corresponding article outlets 102. The articles to be sorted are delivered from article outlets 102 into storage devices 103 on article collecting device 101 located below, and then they are moved away from article outlets 102 according to a control instruction of control system 201 and wait for further instructions. The processes above are repeated till all the articles to be sorted are delivered into storage devices 103. In the meantime, detection device 204 constantly detects whether there is a storage device 103 which is full of articles, and when detection device 204 detects that there is a storage device 103 that is filled up with articles, control system 201 directs transfer device 203 to transfer the storage device 103 that is full (or which contains a completed order) and to further place a replacement empty storage device 103 at the position where the transferred storage device 103 was. This process is continued till sorting of all the articles to be sorted is completed. In some embodiments, one or more of these steps can be performed manually by a person.

In one embodiment, the article sorting system can make full use of the area of article sorting device 100 thereby increasing a plurality of effective article outlets 102 and solving the traditional problem of goods accumulation and thereby greatly increasing checking efficiency, so as to make the whole operation flow of the article sorting more systematized and intelligentized. In some embodiments, a “double” structure can be creatively adopted, with the article sorting device 100 and the article collecting device 101 being arranged one above the other for sorting articles, wherein the article outlets 102 on the article sorting device 100 are in communication with or otherwise in aligned positioning with the article collecting device 101. During article sorting, the articles to be sorted can enter the article collecting device 101 arranged below just by passing through the article outlets 102, thereby completing the sorting. In some embodiments, the article outlets 102 can be flexibly arranged on the edges of the article sorting device 100 or at middle positions of the edges, rather than only being provided at the edges of the article sorting device 100. The middle position in some examples of the present invention refers to positions on the article sorting device 100 other than the edges. In some set ups, this set up can result in the utilization ratio of the article sorting device 100 being improved, the transport path for article sorting being shortened, the article sorting efficiency being increased.

According to Example 2, in order to improve the article sorting efficiency, preferably, each of the article checking inlets is provided with one article information acquisition device, the article checking inlets are in one-to-one correspondence with the article information acquisition devices, and obtaining the destinations of the articles to be sorted includes: acquiring, by the respective article information acquisition devices, the article information of the articles to be sorted that enter the article checking inlets corresponding to the article information acquisition devices, with the article information containing the destinations of the articles to be sorted.

There are many manners for the article information acquisition devices to acquire the article information on the articles to be sorted. Preferably, the destination information is carried in a destination address information code, the destination address information code is provided on the article to be sorted, each of the article information acquisition devices includes a scanner, and the scanner is configured to scan the information code for obtaining the destination of the article to be sorted. For example, the articles to be sorted are provided thereon with information codes containing destination information of the articles to be sorted, and the article information acquisition devices obtain the destinations of the articles to be sorted by scanning the information codes on the articles to be sorted, wherein the information code may be a bar code, a QR code, an RF Tag etc., and correspondingly, the article information acquisition device may be a bar code scanner, a two-dimensional code scanner, a radio frequency identifier, etc., and the mobile transport device may be an auto-navigating small vehicle. According to actual demands, in addition to the destination, the article information may further contain information about the article volume, weight etc., and correspondingly, the article information acquisition device may further include a weighing device, a volume scanner, etc.

While the article information is highly-efficiently obtained, in order to improve the efficiency of subsequent sorting, preferably, after the plurality of article information acquisition devices simultaneously acquire the article information of the respective articles to be sorted, the control device is used to complete the analytical processing of the obtained article information of all the articles to be sorted, thereby obtaining the destination information of the respective articles to be sorted. For example, the system can further include a control device and a plurality of mobile transport devices, wherein the correspondence relationships between the article outlets and the articles to be sorted that go to different destinations are preset in the control device. Transporting the articles to be sorted to the article outlets corresponding to the destinations of the articles to be sorted can include the steps of obtaining, by the control device, the article information acquired by all the article information acquisition devices to obtain the destinations of the respective articles to be sorted; and controlling at least one of the mobile transport devices, according to the obtained destinations of the articles to be sorted, to transport the articles to be sorted to the article outlets corresponding to the destinations of the articles to be sorted.

After obtaining the article information, in order to improve the efficiency of the subsequent sorting processes, the system can further include a detection device and a transfer device. The method can furthermore include obtaining, by the control device, the information detected by the detection device about whether the storage device is full or not, and when obtaining information indicating that the storage device is full, transmitting to the transfer device an instruction for transferring the storage device which is full. The method can also include obtaining, by the control device, the information detected by the detection device about whether the order is complete or not. In one example, the order can be complete before the storage device is filled up. The method can include ordering the removal of a destination container and replacing it with a replacement container when an order is complete even when the destination container is only partially full. In one alternate situation where an order may fill more than one container, for example, the method can include ordering the removal of first destination container and replacing it with a second container. The method further includes determining that the first order (that consists of articles in both the first destination container and the second destination container) has been completed.

After the control device has already obtained the destinations of the respective articles to be sorted at the respective article checking inlets, the article sorting can be completed just by obtaining the transport paths of the respective articles to be sorted through analysis according to the positions of the article outlets corresponding to the destinations of the respective articles to be sorted, and then controlling at least one of the mobile transport devices to transport, according to the transport paths, each of the articles to be sorted to the article outlets corresponding to the destinations of the articles to be sorted. The analysis by the control device on the transport paths of the respective articles to be sorted can be performed simultaneously. After completing the path analysis, the plurality of mobile transport devices may be simultaneously controlled to simultaneously complete transporting of the respective articles to be sorted, thereby significantly improving the article sorting efficiency.

Each of the mobile transport devices is configured to load one article to be sorted or a plurality of articles to be sorted that go to the same destination. The mobile transport device can be further configured to transport one article to be sorted one time, and the control device can send a control instruction to the mobile transport device after obtaining the destination of the article to be sorted that is going to be transported by the mobile transport device, such that the mobile transport device travels to the position of the article outlet corresponding to the destination of the article to be sorted.

The articles to be sorted may be manually loaded onto the mobile transport device, and the articles to be sorted may also be automatically loaded onto the mobile transport devices by intelligently controlling article gripping devices or the like through the control device. Similarly, the transport of the articles to be sorted from the article outlets to the article collecting device can be performed manually and may also be completed by intelligently controlling article gripping devices or the like through the control device.

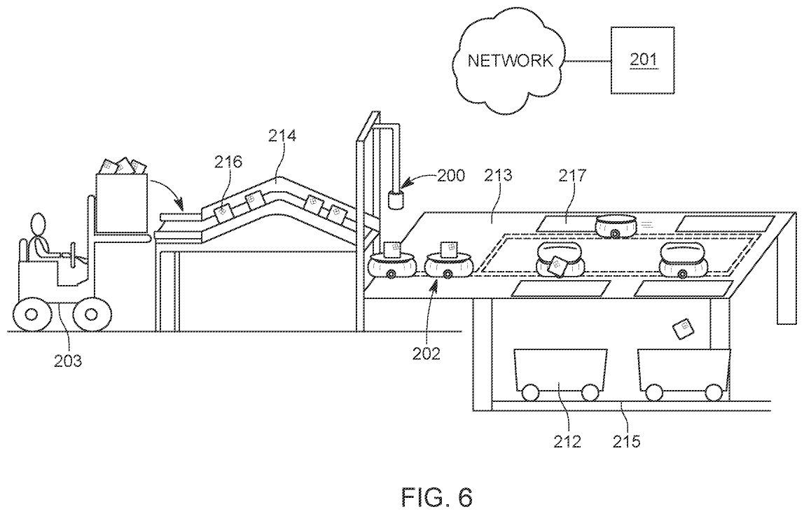

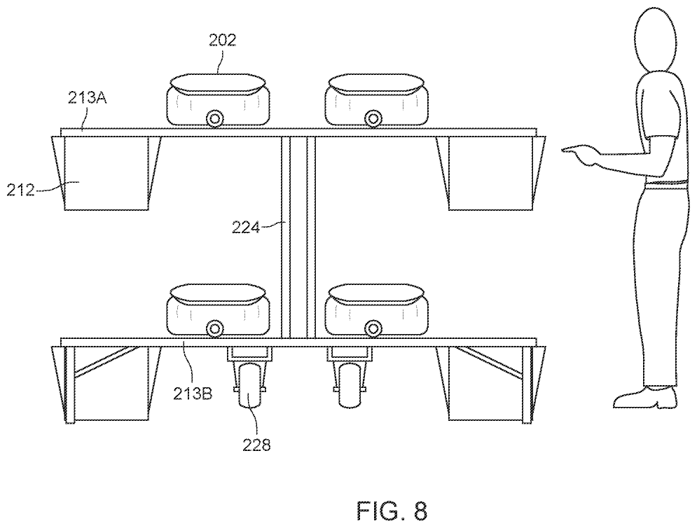

According to Example 3, as illustrated in FIG. 6, according to some embodiments, a system for use in an order fulfillment center or any other facility that receives orders or listings of articles for an order is provided. The system includes one or more platforms 213 that is elevated proximal to a lower level 215 that is lower than the level of platform 213. Each of these platforms 213 provide a surface for mobile transport device 202 to traverse to deposit one or more articles to a destination container 212 via an article outlet in the form of opening 217. In operation, a device or conveyor delivers a container of articles proximal a chute 214 or other material handling system. The material handling system delivers the container of articles to an article supply location. The container may contain products that are identical or may contain disparate products. Openings 217 provided for the dropping of articles are optional in that as illustrated, for example, in FIG. 8, destination containers 212 can alternately be provided along an edge of platform 213.

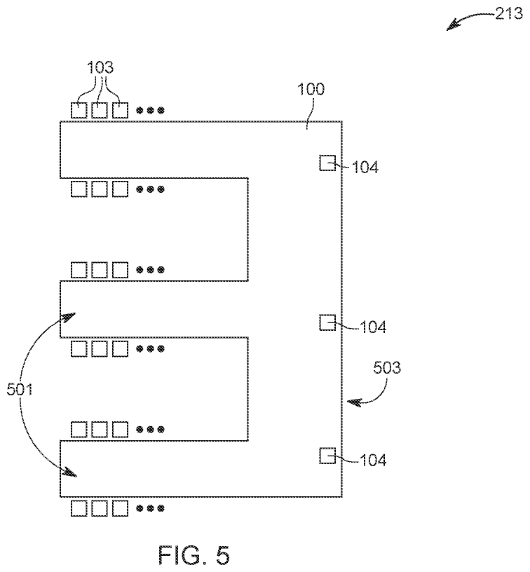

Referring to FIG. 5, in some embodiments, platform 213 can be in the form of fingers 501 and a highway 503. In this embodiment, article checking inlets 104 are arranged along highway 503 whereas storage devices 103 are arranged along fingers 501, both in the manner illustrated in FIG. 5. In some embodiments, the article checking inlets 104 and the storage devices 103 can be arranged in alternate locations or in other locations, as needed.

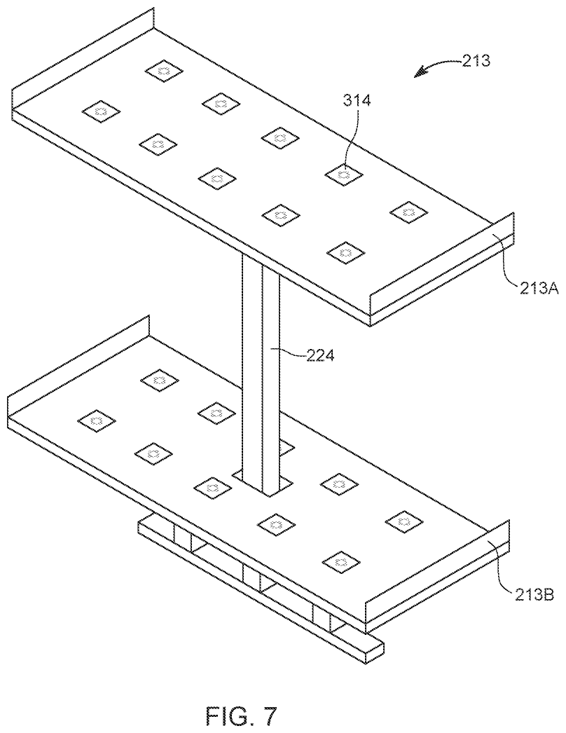

Referring to FIG. 8, in instances wherein platform 213 comprises sort platform panels such as first panel 213A and second panel 213B, destination containers 212 can alternately be provided along an edge of first panel 213A and second panel 213B. Accordingly, in some embodiments, platform 213 can include two or more platforms stacked one above the other, for example, with such two or more platforms being substantially parallel to, a plane such as lower level 215 illustrated in FIG. 6. In one implementation, as illustrated in FIG. 7, platform 213 can include a first panel 213A and a second panel 213B connected by the center support 224, with the first panel 213A being elevated compared to the second panel 213B. As illustrated in FIG. 7, first panel 213A and second panel 213B can include markers 314 marked thereon to assist with the navigation of mobile transport devices 202. Accordingly, in some embodiments, platform 213 may include more than two panels, with the panels positioned above and below one another and/or next to each other. In further embodiments, a system of platforms may have additional platforms 213 added to the system in a modular and scalable manner to change the functional capacity, design, or capability of the sortation system. The mobile transport device 202 carrying thereon one or more articles associated with an order and travelling on platform 213 may be directed by control system 201 to deposit the one or more articles into a specific destination container 212 associated with a specific marker 314 based on the location of the specific marker 314. Control system 201 may electronically store the locations of each marker 314 to assist with this.

Accordingly, while FIG. 6 illustrates a single platform, with destination containers 212 positioned on the floor or another platform that is lower than a plane where destination containers are located, as illustrated in FIG. 7, platform 213 can include two or more panels such as first panel 213A and the second panel 213B supported by a support such as center support 224. The setup as illustrated in FIG. 7 and FIG. 8 can accordingly allow for two or more sort levels to improve efficiency thereby further.

In various embodiments, markers 314 may include RFID tags, QR codes, magnetic arrays, other navigation or location identification methods, and the like. FIG. 8a illustrates one example of marker 314 that includes a RFID tag that is bordered by one or more magnets that are inducted, taped, or applied by other means to the surface of first panel 213A. The system may include any number of other types of navigation or location identification methods. In one embodiment, marker 314 may include a magnetic array comprising magnetic bars that extend from a periphery of a RFID tag and create a combined magnetic field. In an alternate embodiment, marker 314 may include a magnetic array comprising magnetic bars that extend from a periphery of a QR code. In a further embodiment not illustrated herein, one magnetic bar may be “missing” in order to alter the magnetic field. In another embodiment, one magnetic bar may be “double stacked” on another magnetic bar on one side. In a furthermore embodiment, in addition to, or in lieu of, the above noted arrangements, one magnetic bar may be of the opposite magnetic polarity as the others. The magnetic bars may further follow other patterns in order to produce various magnetic signatures. By reading the RFID tag and by further measuring the magnetic force with an interrogator and imaging device (the magnetic force corresponding to the magnetic field that produces the magnetic signature), the control system can advantageously determine a location (by the RFID tag) and an orientation (by the magnetic force) of each marker 314. A RFID reader or a similar other measurement system may interact with the RFID tag for determining location.

Referring to FIG. 8, destination containers 212 can be in the form of totes. Further, platform 213 can include two panels, i.e., a second panel 213B in addition to the first panel 213A, the first panel 213A and second panel 213B being connected by a center support 224—with the first panel 213A elevated higher than the second panel 213B. In various embodiments, platform 213 can thus be embodied in a multiple level arrangement that includes an elevated platform (e.g., first panel 213A) above a lower level, which may be the floor or a second platform (e.g., second panel 213B). The second panel 213B may be identical to the first panel 213A in structure, layout, function, utility etc. Platform 213 can further include wheels 228 or similar other mechanism to provide mobility to the platform 213, for example, from a storage location to a sorting location. Further, as illustrated in FIG. 8, the first panel 213A and second panel 213B can further includes provisions for detachably securing the destination containers 212 to platform 213. Accordingly, as illustrated in FIG. 8, in some embodiments, the destination containers 212, instead of being positioned on the floor or another platform that is lower than second panel 213B, can be detachably secured to second panel 213B itself; similarly, additional destination containers 212, instead of being positioned on the floor or another platform that is lower than first panel 213A, can be detachably secured to first panel 213A itself. Accordingly, in various embodiments, destination containers 212 can be provided along the edge of sort platform panels such as first panel 213A and second panel 213B. Destination container 212 can represent a tote, a carton, a bag, a shipping container, an accumulation device, and/or a chute that is provided along the edge(s) of first panel 213A and second panel 213B.

In at least one embodiment, when article sorting device 100 determines that an order has been completed, article sorting device 100 proceeds to update an electronic database to reflect this, with article sorting device 100 being in electronic communication with the electronic database. In one embodiment, the electronic database may reside in the cloud. According to at least one embodiment, each time the computer-controlled device deposits an item into a destination container, the control system will update the status of the order in the electronic database. An operator may select one or more articles from the container and image an identifier 216 positioned on each of one or more articles via the article information acquisition device 200. Optionally, the article information acquisition device 200 may automatically interact with identifier 216 for article recognition. The operator may place the one or more articles on the mobile transport device 202, or the system and process may be set up so that such deposition of the one or more articles onto mobile transport device 202 is automated. The article information acquisition device 200 may then communicate the article identifier information associated with each of the one or more articles to the control system 201.

The article supply, namely the articles shown in the containers, may be a supply of articles that has an identifier 216 on each article. The article information acquisition devices 200 obtain the information contained in the identifier 216 of the articles to be sorted by identifying the information codes on the articles to be sorted, wherein the information code may be a bar code, a two-dimensional code, a radio frequency tag etc., and correspondingly, the article information acquisition device 200 may be a bar code scanner, a two-dimensional code scanner, a radio frequency identifier, etc. Additionally, the information acquisition device may be configured to image the one or more articles and compare against a database of known articles to determine a characteristic, SKU, or identity of each of the one or more articles.

According to one embodiment, an operator may select an article from the delivered container and image an identifier 216 positioned on the article via article information acquisition device 200. Optionally, article information acquisition device 200 can automatically interact with the identifier 216 for article recognition without the need for any action on the part of the operator. The operator can place the article on the mobile transport device 202, or the system and process may be set up so that such deposition of article onto mobile transport device 202 is automated. Article information acquisition device 200 can then communicate the article identifier information to control system 201 in communication with article information acquisition device 200 via the network. Mobile transport device 202 may have a first position in which one or more articles are stowed about the device and a second position in which the one or more articles are deposited into a proximal destination container. In one or more embodiments, mobile transport device 202 may be an auto-navigating small device.

In at least one embodiment, control system 201 forming part of the control system is configured to receive an order for a plurality of disparate articles to fulfill an order. The disparate articles may be a plurality of similar articles having different sizes, colors, and the like, such as apparel, or the disparate articles may be largely unrelated. Control system 201 can be configured to determine one destination container of a plurality of destination containers to deposit, with the mobile transport device, a selected article. Control system 201 can be configured to direct the mobile transport device to transport the selected article which is stowed about the vehicle to the destination container and deposit the article by manipulation of the mobile transport device from the first position to the second position for deposit of the selected article in the destination container. Control system 201 can be configured to determine one destination container 212 among a plurality of destination containers to deposit, with the mobile transport device 202, a selected article based on the interaction with the identifier 216. Control system 201 is further configured to direct the mobile transport device to transport the selected article to the destination container and deposit the article by manipulation of the mobile transport device from the first position to the second position for deposit of the selected article in the destination container.

In various embodiments, the system may be embodied in a multiple level arrangement. The multiple level arrangement may include an elevated platform above a lower level, which may be the floor or a second platform. In operation, the control system determines that a destination container needs an article deposited therein. In the multiple level arrangement, the destination container is positioned proximal an opening in the elevated platform. The mobile transport device traverses the elevated platform to the destination container and deposits the article by manipulation of the mobile transport device from the first position to the second position for deposit of the selected article in the destination container.

As an example, consider a situation at an order fulfillment facility where an order calls for 3 red shirts, 2 blue shirts, and 2 pair of blue jeans to be transported to an end destination retailer. The control system 201 may know that at article supply #1 are the red shirts, article supply #5 has blue shirts, and article supply #13 has blue jeans. The control system 201 directs a respective mobile transport device 202 to each of article supply #1, article supply #5, and article supply #13. The control system 201 also determines or otherwise knows that the destination container for delivery of the order is located at a certain location on the platform. The control system 201 then directs each respective mobile transport device 202 to deposit articles into the destination container until the entire order is filled. At that time, the control system 201 knows that the order is filled and can direct or otherwise instruct removal of the destination container.

The control system may be further configured to direct the mobile transport device to return to be proximally located at any article supply. The mobile transport device is in the first position upon being proximal at an article supply. The control system may be further configured to direct a plurality of mobile transport devices such that the mobile transport devices do not collide with one another.

Disclosed herein is thus a system that includes an article supply. The article supply includes a plurality of articles at an order fulfillment center or a shipment center. In operation, the system has a method or material handling system to move and transport containers of articles. The method or material handling system delivers a container of articles to an article supply location. The container may contain product that is identical or may be disparate product. A control system 201 communicates over a network. The network may be a wired or wireless network. The wireless network may be Bluetooth®, WIFI, a specific Radio Frequency band, cellular, and the like. The control system 201 may be embodied as a server with a processor and a memory, where the processor executes many instructions provided herein. Control system 201 may be configured to receive an order for a plurality of disparate articles to fulfill an order. The disparate articles may be a plurality of related articles having varied sizes, colors, and the like, such as apparel, or the disparate articles may be largely unrelated. Control system 201 may be configured to determine one destination container of a plurality of destination containers to deposit, with the mobile transport device, one or more selected articles.

Control system 201 may be configured to direct the mobile transport device to transport the selected one or more articles which are stowed about the device to the destination container and deposit the one or more articles by manipulation of the mobile transport device from the first position to the second position for deposit of the selected one or more articles in the destination container.

Control system 201 may be configured to direct the mobile transport device to transport one or more articles to the destination container and deposit the one or more articles by manipulation of the mobile transport device from the first position to the second position for deposit of the selected one or more articles in the destination container. Control system 201 may be configured to determine when the order is complete. The system may include an article information acquisition device 200 that is configured to image the selected article. The control system may further determine a characteristic of the selected article by interacting with the selected article with the information acquisition device. This interaction may include optical recognition to determine one or more characteristic of articles that can include size, color, deformation or other defect, UPC or other identifying code, and the like. The control system can be further configured to determine a characteristic of the selected article by interacting with an identifier 216 of the selected article with the information acquisition device. The identifier may be a UPC or other similar other product code associated with the article. The control system may be further configured to determine a characteristic of each of the selected one or more articles by interacting with an identifier 216 provided on each of the selected one or more articles with the information acquisition device.

The system may further include an elevated platform above a lower level. The mobile transport device traverses the platform. The destination container is positioned proximal a recess in the platform. The mobile transport device traverses the platform, positions the device proximal the recess and then manipulates from the first position to the second position to deposit the article. Each mobile transport device may carry a respective single selected article, and multiple mobile transport devices may be traversing the platform at any given time. The control system may be configured to direct the mobile transport device to return to a position proximal an article supply. The mobile transport device is in the first position upon being proximal an article supply. The control system may be configured to direct a plurality of mobile transport devices. The control system is further configured to direct the plurality of mobile transport device is such that the mobile transport devices do not collide with one another.

A method is provided. The method may include receiving an order for a plurality of disparate articles, determining one destination container of a plurality of destination containers to direct the mobile transport device to deposit a selected article, directing the first mobile transport device to transport the selected article to the destination container and deposit the article by manipulation of the first mobile transport device from the first position to the second position for deposit of the selected article in the destination container, directing the second mobile transport device to transport a disparate article to the destination container and deposit the disparate article by manipulation of the second mobile transport device from the first position to the second position for deposit of the selected disparate article in the destination container, and determining when the order has been completed. The method can further include directing removal of the first destination container. In some embodiments, the method further includes directing an order-removing equipment to perform removal of the first destination container. In one embodiment, the method further includes replacement with a second container to receive the continuation of a large order or a new order.

According to Example 4, in another example utilizing the same or many of the components discussed regarding Example 3, a control system receives an order for fulfillment. The order, in this example, may include articles from various portions of a warehouse or fulfillment center. The control system can batch orders, thus allowing for multiple orders to be fulfilled at once in a time efficient manner. The control system may then determine that a plurality of articles to be sorted are located within an article storage area of the fulfillment center, and a second plurality of articles to be sorted are located within a second portion of the fulfillment center, and the like. The plurality of articles can span batched orders. The control system may then direct a person or an automated machine to pull the plurality of articles associated with the orders where the articles are in a first article storage area of the fulfillment center. Those pulled articles in the first article storage area may then be positioned in a case, bin, or other container. Similarly, the pulled articles in the second location may then be positioned into a separate case, bin, or other container. The control system may similarly direct a person or an automated machine to pull the plurality of articles associated with the batched orders where the articles are in a second location of the fulfillment center. The bin or other container is then taken to a conveyor, chute, AMR (autonomous Mobile Robot) or the like to transport the pulled articles to a location of article supply. A person may then position an article onto a mobile transport device, or an automated machine may then position the article onto the mobile transport device.

The information acquisition device may then image the UPC or other identifying code on the article to determine the article identity. The information acquisition device then communicates the article identity to the control system, which is then able to compare the article identity to the database of orders that have been batched and assign a destination container for depositing the article based on the orders. The control system then does this for each item until the orders are filled. The destination container can be positioned below the platform, where a chute may extend from the elevated platform to the destination container in order to guide the article into the destination container.

According to Example 5, in another example utilizing the same or many of the components discussed in regard to Example 3, a control system receives an order for store fulfillment. The order, in this example, may include articles from various portions of a warehouse or fulfillment center. The control system can allow for batching orders for stores, thus allowing for multiple store orders to be fulfilled at once in a time efficient manner. The control system may then determine that a plurality of articles to be sorted are located within an article storage area of the fulfillment center, and a second plurality of articles to be sorted are located within a second portion of the fulfillment center, and the like. The plurality of articles spans the store orders. The control system may then direct a person or an automated machine to pull the plurality of articles associated with the stores orders where the articles are in the article storage area of the fulfillment center. Those pulled articles in the first location may then be positioned in a case, bin, or other container. Similarly, the pulled articles in the second location may then be positioned into a separate case, bin, or other container. The bin or other container is then taken to a conveyor, chute, small vehicle, or the like to transport the pulled articles to a location of article supply. A person may then place an article onto a mobile transport device, or an automated machine may then place the article onto the mobile transport device. The information acquisition device may then image the UPC or other identifying code on the article to determine the article identity. The information acquisition device then communicates the article identity to the control system which is then able to compare the article identity to the database of store orders that have been batched and assign a destination container for depositing the article based on the individual store. The control system then does this for each article until a store order is filled.

The control system may be further configured to segregate a store order into departments such that all articles for a given store department are assigned to a single destination container. Store departments may include or be defined as women's, men's, shoes, etc. The destination container may be positioned below the platform, where a chute may extend from the elevated platform to the destination container in order to guide the article into the destination container.

According to Example 6, in another example utilizing the same or many of the components discussed regarding Example 3, an operation receives returns of articles from a customer. The returns arrive at a returns processing area and are received into the facility. In operation, a method, device, or conveyor delivers a container of returned articles proximal a chute or other material handling system or method. The material handling system or method delivers the container of returned articles to an article supply location. An operator may then place a single returned article onto a mobile transport device, or an automated machine may then place the article onto the mobile transport device.

The information acquisition device may then image the UPC or other identifying code on the article to determine the article identity. The information acquisition device then communicates the article identity to the control system, which is then able to compare the article identity to the database of the articles in the article master database and assign a destination container for depositing the article based on the article identity or SKU. The control system then does this for each article until all returned articles have been transported and deposited into destination containers. The control system can be configured to transport and deposit identical or related articles into a single destination container. The destination container may be positioned below the platform, where a chute may extend from the elevated platform to the destination container in order to guide the article into the destination container.

According to Example 7, in another example utilizing the same or many of the components discussed regarding Example 3, a control system receives an order for fulfillment. The order, in this example, may include articles from various portions of a warehouse or fulfillment center. The control system batches orders, thus allowing for multiple orders to be fulfilled at once in a time efficient manner. The control system may then determine that a plurality of articles to be sorted are located within an article storage area of the fulfillment center, and a second plurality of articles to be sorted are located within a second portion of the fulfillment center, and the like. The plurality of articles spans the batched orders. The control system may then direct a person or an automated machine to pull the plurality of articles associated with the batched orders where the articles are in the article storage area of the fulfillment center. Those pulled articles in the article storage area may then be positioned in a case, bin, or other container. Similarly, the pulled articles in the second location may then be positioned into a separate case, bin, or other container. The bin or other container is then taken to a conveyor, chute, or the like to transport the pulled articles to a location of article supply. A person may then position an article onto a mobile transport device, or an automated machine may then position the article onto the mobile transport device.

The information acquisition device may then image the UPC or other identifying code on the article to determine the article identity. The information acquisition device then communicates the article identity to the control system, which is then able to compare the article identity to the database of orders that may have been batched and assign a destination container for depositing the article based on the orders. The control system then does this for each item until the orders are filled. The destination container may be positioned on the same platform or surface as the mobile transport device and the mobile transport device may deposit directly into the destination container.

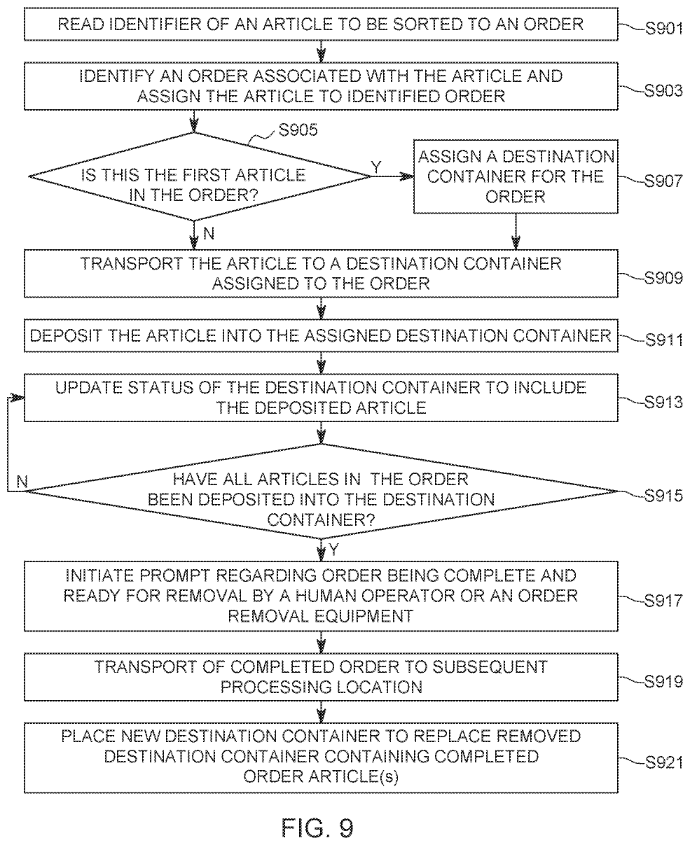

FIG. 9 illustrates an exemplary method according to one or more embodiments of the presently disclosed subject matter. At step S901, an identifier associated with an article to be sorted to an order is read. In one embodiment, an article sorting system directs the reading or scanning of an identifier of an article to be sorted, for example, by an article information acquisition device. At step S903, an order associated with the article is identified on the identifier, and the article is assigned to the identified order. For example, in one embodiment, the article sorting system directs the identification of an order associated with the article based on the scanned identifier and the assignment of the article to the identified order. At step 905, if the article sorting system determines that the article is the first article in the order, the article sorting system assigns a destination container for the order at S907. If at step 905, if the article sorting system determines that the article is not the first article in the order, the article sorting system directs the transport of the article to a destination container that has previously or already been assigned to the order at step S909.

At step S911, the article sorting system directs the deposit of the article into the assigned destination container. At step S913, the article sorting system electronically updates the status of the destination container to include the deposited article. At step S915, the article sorting system determines whether all articles associated with the order have been deposited into the destination container; in other words, at step S915, the article sorting system determines whether all articles associated with an order that has been assigned to a given destination container have been deposited into that destination container (i.e., whether the destination container includes all orders that are part of the order). If the article sorting system determines that all articles in the order have not been deposited into the destination container at step S915, the article sorting system returns to steps S913 and updates status of the destination container to include the deposited article. If the article sorting system determines that all articles in the order have been deposited into the destination container at step S915, the article sorting system directs the initiation of a prompt regarding the order being complete and further being ready for removal by a human operator or by an order removal equipment then at step S917. At step S919, the article sorting system directs transport of completed order to subsequent processing location. At step S921, the article sorting system directs placement of a new destination container to replace removed destination container containing completed order article or articles. The article sorting system may further allow a new order to be assigned and filled in the new container. The article sorting system may further allow for store replenishment and other situations where a same container can be filled over and over for fulfilling the needs of a store or for department within a single specific store.

According to one or more embodiments, a system for sorting articles to one or more destinations includes an article supply location. The article supply location includes a plurality of articles to be sorted. The system also includes a first computer-controlled mobile transport device such as mobile transport device 202 having a first position in which an article is stowed about the device and a second position in which the article is deposited into a proximal destination container such as destination container 212. The system also includes a platform 213 elevated from a first surface, wherein the first computer-controlled mobile transport device traverses the platform, and the stowed articles are deposited into a destination container positioned proximal the platform. The system further includes a control system that can include control system 201. The control system can include a memory and a processor. The control system is configured to receive a first order for a plurality of disparate articles found within the article supply location. The control system is further configured to assign a first destination container of a plurality of destination containers to the first order to direct the first computer-controlled mobile transport device to deposit a first article and a second article into the first destination container based on a product type of each article with the first and second articles being selected from the plurality of disparate articles. The first and second articles from the article supply location are both deposited at a same instant onto the first computer-controlled mobile transport device.

Accordingly, in various embodiments, the first and second articles may be deposited together onto the first computer-controlled mobile transport device whereby the first computer-controlled mobile transport device can deliver the first and second articles to the first destination container in a single trip, thereby saving valuable resources. Whereas existing technics may require two trips by a device to transport two articles to a single destination container, embodiments as disclosed herein can transport two articles to a single destination container in a single trip. In some alternate embodiments, the control system as disclosed herein can transport two articles, deposit one of the two articles in a first destination container and the other of the two articles in a second destination container in a single trip before returning to an article loading point for reloading. In some embodiments, the first computer-controlled mobile transport device transports three articles in a single trip, depositing two of the three articles into a first destination container associated with a first order, and depositing the remaining third article in a second destination container associated with a second order.

The control system as disclosed herein can further direct the first computer-controlled mobile transport device to transport and deposit both the first and second articles in the first destination container in a single trip by manipulation of the first computer-controlled mobile transport device from the first position to the second position. The control system as disclosed herein can further determine when the first order has been completed. In some embodiments, the first order includes only one article. In one embodiment, the first order includes two or more articles. In some embodiments, the first computer-controlled mobile transport device transports at least three articles associated with the same first order in a single trip.

In some embodiments, the control system is further configured to receive a second order for a plurality of disparate articles found within the article supply location, and assign a second destination container of the plurality of destination containers to the second order to direct a second computer-controlled mobile transport device to deposit a third article and a fourth article into the second destination container based on a product type of each article, the third and fourth articles selected from the plurality of disparate articles. The third and fourth articles from the article supply location are both deposited at a same instant onto the second computer-controlled mobile transport device. The second computer-controlled mobile transport device has a first position in which an article is stowed about the device and a second position in which the article is deposited into a proximal destination container. The second computer-controlled mobile transport device traverses the platform. The control system is further configured to direct the second computer-controlled mobile transport device to transport and deposit both the third and fourth articles in the second destination container in a single trip by manipulation of the second computer-controlled mobile transport device from the first position to the second position. The control system further determines when the second order has been completed.

In some embodiments, the first order can further include a fifth article, wherein the control system is configured to update a status of the first order after deposition of the first and second articles in the first destination container but before the deposition of the fifth article in the first destination container. The control system is further configured to determine an identity of the fifth article before it is deposited in the first destination container to complete the first order.

In some embodiments, the control system is further configured to direct removal of the first destination container for shipment processing, and direct placement of a replacement destination container at a location of the removed first destination container. In some embodiments, the removal of the first destination container is done manually. In some embodiments, the placement of the replacement destination container too is done manually. In at least one embodiment, the control system is further configured to direct removal of all articles in the first destination container for shipment processing and assign a third order to the first destination container.

In some embodiments, an order-removing equipment performs removal of the first destination container. In various embodiments, the order-removing equipment can represent any suitable mechanism already known in the art including mechanisms such as a rail-based equipment, an autonomous mobile robot (AMR), an automated guided vehicle (AGV), and a self-propelled first destination container. Accordingly, in some embodiments, the first destination container can be similar to mobile transport device 202 such that the first destination container can be configured to travel to a shipment processing location after all articles associated with the first order articles have been deposited into the first destination container. In some embodiments, each of the plurality of destination containers includes wheels to provide mobility. However, the destination containers may or may not include wheels. The article storage area within the article sorting center from which the articles to be sorted are pulled can represent any location wherein disparate articles associated with a plurality of orders are received and sorted for shipment to a plurality of locations. Accordingly, the article sorting center can represent a distribution center, a retail store, a micro fulfillment center, store backroom facility, a shipping facility, or a similar other facility. The articles can also be pulled directly from trucks. In one embodiment, the articles can be pulled from article storage locations of an article sorting center.

Referring to FIGS. 7 and 8, platform 213 can include a first panel 213A and a second panel 213B wherein the first panel 213A is elevated compared to the second panel 213B. Platform 213 can include wheels 228 to provide mobility. However, platform 213 may or may not include wheels. In some embodiments, the destination containers can represent a tote, a carton, a bag, a shipping container, an accumulation device, a chute, and/or a similar other mechanism. In some embodiments, the destination containers 212 are positioned proximal an edge of the platform, as illustrated in FIG. 8. In some alternate embodiments, the first computer-controlled mobile transport device traverses a platform proximal an article outlet 102 in the form of an opening in the platform, then manipulates from the first position to the second position to deposit the first and second articles into the destination container through the opening in the platform.

In various embodiments, the control system is further configured to direct an automated deposition of the first and second articles onto the first computer-controlled mobile transport device. In other words, the induction of the first and second articles onto the first computer-controlled mobile transport device is performed automatically as controlled by the control system. In some alternate embodiment, the induction of the first and second articles onto the first computer-controlled mobile transport device is performed manually whereby a human operator loads the first and second articles onto the first computer-controlled mobile transport device.

In some embodiments, the control system is also configured to direct transport of the first destination container to a shipment processing location after all articles associated with the first order have been deposited into the first destination container. The shipment processing location can include shipping, packing and any other downstream operation. In some embodiments, the control system is further configured to assign a new order to a replacement destination container that is placed in the location from where the first destination container was removed after all articles associated with the first order have been deposited into the first destination container. In some embodiments, after all articles associated with the first order have been deposited into the first destination container, the control system is further configured to direct further tasks including subsequent packaging, labelling, gift wrapping, quality control checking, and shipping of the first order to its ultimate customer destination.

In at least one embodiment, the platform can include multiple levels with each level including a plurality of destination containers. In some embodiments, the weight and volume of each article is captured by the control systems. In some embodiments, the induction of the articles is done automatically. In some embodiments, each time the computer-controlled device deposits an article into a destination container, the control system will update the status of the order associated with either the article or the destination container. In some embodiments, when all articles for a given order have been deposited in the destination container, the control system will indicate that the order is ready be removed from the destination location. After the order is removed and the destination is prepared to receive more articles, the control system assigns a new order to the destination.

In some embodiments, the control system directs the completed order to another location in the facility for further processing. The order may be removed by a human operator or by equipment designed to move the completed order. The order may be removed either by removing the container or by emptying the container. If the destination container is removed, it is replaced with another container by the human operator or the order-moving equipment. The order-removing equipment may be rail-based, AMR, AGV, or the destination containers themselves may include a drive system embedded in them.

In some embodiments, order locations may be optimized by the control system by positioning a relatively large order nearest to the article supply location to minimize travel distance by the device. In some embodiments, order completion may be optimized by the control system by sending an article which is needed in multiple orders to an order which is waiting on that item to be completed. The “further processing” of the completed order may include packaging, labeling, gift wrapping, addition of more articles to the order, quality control, shipping, etc. In some embodiments, the platform can include a highway-and-fingers layout or a backroom layout. In some embodiments, the platform can include a highway and a single-finger layout or configuration.

In some embodiments, the control system directs the completed order to another location in the facility for further processing. The order may be removed either by removing the container or by emptying the container. In some embodiments, order completion is optimized by the control system by sending a same article that is to be included in multiple order to be first deposited in a destination container such that the dropping of the article completes the order thereby allowing for the removal of the destination container immediately thereafter for subsequent processing.

The system includes a first article supply location. The first article supply location includes a plurality of articles to be sorted that have been pulled from orders from a first location in a distribution center. It is to be noted that while the sorting operations according to various embodiments of the presently disclosed subject matter may be described in the context of a distribution center, embodiments of the presently disclosed subject matter apply equally to all other locations that can benefit from the sorting operations disclosed herein including, but not limited to, retail store, dark store, micro fulfillment center, grocery store, or a similar other location; all such locations may alternately be referred to herein as “article sorting center”. A second article supply location includes a plurality of articles to be sorted. In one embodiment, the plurality of articles to be sorted can be pulled from orders from a second article storage location in the article sorting center. In one embodiment, the plurality of articles to be sorted can come directly from trucks. A product type of each article is determined by interacting with an information acquisition device at the respective first article supply location and second article supply location. First and second computer-controlled mobile transport devices include a first position in which a selected article is stowed about the device and a second position in which the selected article is deposited into a proximal container by manipulating a support of the device that carries the selected article and deposits the selected article when in the second position. A first platform is elevated from a first surface. The first computer-controlled mobile transport device traverses the first platform, and the selected articles are deposited into a destination container positioned about the first surface.

According to various embodiments, the control system is configured to receive an order for a plurality of disparate articles. In one embodiment, the disparate articles are found within the first or second article supply location after the articles have been pulled from a first article storage location of the article sorting center. The control system is configured to determine a first destination container of a plurality of destination containers to direct the first mobile transport device to deposit a selected article from the first or second article supply location based on the determined product type. The destination container corresponds with an order for a first business. The control system is configured to direct the first mobile transport device to transport the selected article to the destination container and deposit the selected article by manipulation of the first mobile transport device from the first position to the second position for deposit of the selected article in the destination container. The control system is configured to determine a second destination container of a plurality of destination containers to direct the second mobile transport device to deposit another article from the first or second article supply location based on the determined product type. The second destination container corresponds with an order for a second customer or a second entity. The control system is configured to direct the second mobile transport device to transport a disparate article to the destination container and deposit the disparate article by manipulation of the second mobile transport device from the first position to the second position for deposit of the disparate article in the destination container. The control system is configured to determine when at least one of the orders has been completed.

According to one or more embodiments, the destination container is positioned proximal an opening in the first platform. The first mobile transport device traverses the first platform proximal the opening, then manipulates from the first position to the second position to deposit the article into the destination container through the opening in the first platform. According to one or more embodiments, each of the first mobile transport device and second mobile transport device carries a respective single selected article. According to one or more embodiments, the system includes a plurality of additional mobile transport devices.

According to one or more embodiments, the control system is configured to direct the first mobile transport device to return to a position proximal the first article supply location. The first mobile transport device is in the first position upon being positioned proximal the first article supply location. According to one or more embodiments, the control system is configured to direct a plurality of additional mobile transport devices. The control system is further configured to direct the plurality of additional mobile transport device is such that the mobile transport devices does not collide with one another.

According to one or more embodiments, a control system is configured for use with material handling of a plurality of articles. The control system includes a memory and a processor. The control system is configured to receive a plurality of orders for a plurality of disparate articles, wherein the plurality of disparate articles are received from a first article supply location that has been pulled from orders from a first article storage location in an article sorting center, and a second article supply location that has been pulled from orders from a second article storage location in the article sorting center, interact with an identifier affixed to an article or packaging associated with the article in order to determine a product type of a respective article at the first article supply location or the second article supply location, and determine one destination container of a plurality of destination containers to deposit, with a mobile transport device, a selected article. The destination container is determined based on at least one of the orders and the determined product type of the selected article. The control system is further configured to direct a first mobile transport device to transport the selected article to the determined one destination container and deposit the selected article by manipulation of the first mobile transport device from a first position to a second position for deposit of the selected article in the destination container. The control system is further configured to determine another one destination container of a plurality of destination containers to deposit, with a mobile transport device, a disparate selected article. Another destination container is determined based on at least one of the orders and the determined product type of the disparate selected article. The control system is configured to direct a second mobile transport device to transport the disparate selected article to the another determined destination container and deposit the disparate selected article by manipulation of the second mobile transport device from the first position to the second position for deposit of the disparate selected article in the another determined destination container and determine when at least one order has been completed.

According to one or more embodiments, a system includes a first article supply location, wherein the first article supply location includes a plurality of articles to be sorted that have been pulled from orders from a first article storage location in an article sorting center and a second article supply location, wherein the second article supply location includes a plurality of articles to be sorted that have been pulled from orders from a second article storage location in the article sorting center. A product type of each article is determined by interacting with an information acquisition device with an identifier at the respective first article supply location and second article supply location. A platform assembly includes a platform elevated from a proximal surface. The platform defines an opening and a destination container that is positioned proximal the opening in the platform. The first and second computer-controlled mobile transport devices, each device having a first position in which a selected article is stowed about the mobile transport device and a second position in which the selected article is deposited into a proximal container by manipulating a support of the device that carried the selected article and deposits the selected article when in the second position. The first mobile transport device traverses the platform and positions proximal the opening to deposit the selected article in the destination container by manipulation from the first position to the second position. A control system is configured to receive an order for a plurality of disparate articles. The disparate articles are found within the first and second article supply location after the articles have been sorted and pulled from one or more article storage locations of an article sorting center or directly from one or more trucks. The control system is configured to determine a first destination container of a plurality of receiving destination containers to direct the first mobile transport device to deposit the selected article. The first destination container corresponds with an order for a first business. The control system is configured to direct the first mobile transport device to transport a selected article to the first destination container and deposit the article by manipulation of the support of the first mobile transport device from the first position to the second position for deposit of the selected article in the destination container and determine a second destination container of a plurality of destination containers to direct the second mobile transport device to deposit a disparate selected article from the first or second article supply location based on the determined product type. The second destination container corresponds with an order for a second business. The control system is configured to direct the second mobile transport device to transport the disparate selected article to the destination container and deposit the disparate selected article by manipulation of the support of the second mobile transport device from the first position to the second position for deposit of the disparate selected article in the destination container and determine when the order for purchase has been completed.

According to one or more embodiments, the control system is further configured to determine a characteristic of one of the articles by interacting with the article with the information acquisition device. The characteristic includes one of size, color, deformation, or another defect of the article.

According to Example 1, an additional example utilizing the same or many of the components discussed in regard to Examples 1-7, the disclosed system comprises one or more removal devices configured to relocate a destination container. Particularly, the removal device is configured to relocate a destination container from a position below or alongside a platform as disclosed herein to a location designated for further processing of at least one article contained within the designation container.

As illustrated in FIG. 7, the disclosed system can include platform 250 that extends from a first surface. The platform 250 defines one or more platform openings 255 through which articles are deposited into destination containers 260. One or more computer-controlled mobile transport device 202 traverse platform 250 and are configured to have a first position in which an article is stowed upon mobile transport device 202, and a second position in which the article is deposited into a destination container by manipulating a holder carried by mobile transport device 202. Mobile transport device 202 therefore function to deposit articles stowed thereon into destination containers positioned below an opening in the platform or alongside a position at the edge of the platform by manipulation of the mobile transport device from the first position to the second position. Accordingly, in use, one or more mobile transport devices 202 traverse platform 250 and can be positioned proximal to platform opening 255. In some embodiments, the platform can include a chute or other mechanism that connects platform opening 255 and destination container 260 to guide the article into the destination container.

The system further includes removal device 265 configured to relocate destination container 260 from a position about the first surface (e.g., beneath a platform opening or alongside a location on the edge of the platform) to processing location 270 for further processing of an article contained within the destination container, as illustrated by Arrows A. The processing location can be configured for any desired processing of an article, including, but not limited to, packaging and value-added services such as labeling, gift wrapping, assembly, and the like. In some embodiments, the disclosed system can include a plurality of processing locations 270, and each destination container 260 can be transported via removal device 265 to one or more processing locations 270.

Removal device 265 can transport destination container 260 using any known method. For example, as shown in FIG. 7, in some embodiments, the removal device can include wheels or other mechanical elements to allow movement in a desired direction through any desired mechanism. However, the removal device is not limited and can include any device capable of moving across a surface. For example, in some embodiments, suitable removal devices can include, but are not limited to, automatic guided vehicles (AGVs), automated mobile robots, rail bots, semi-automated vehicles, and the like. In various embodiments, the removal device can be semi-automated or fully automated. In some embodiments, the removal device can include any computer-controlled or user-controlled device known or used in the art. In various embodiments, the removal device can relocate destination container 260 using any desired method. For example, the destination container 260 can be hauled, dragged, toted, carried, lifted, or otherwise moved to processing location 270.

The disclosed system accordingly includes a control system that is configured to receive an order for one or more disparate articles found within an article supply location after the articles have been pulled from a distribution center. The control system determines a destination container 260 to direct a mobile transport device to deposit a selected article based on the determined product type. The product type can be determined by interacting with an identifier of the article (e.g., UPC or other product code associated with the article) with an information acquisition device. The destination container 260 corresponds with an order for a business. The control system directs the mobile transport device 202 to transport the selected article to the destination container 260 and deposit the selected article by manipulation of the mobile transport device 202 from the first position to the second position. The destination container 260 can be positioned proximal to (e.g., beneath) an opening in a first platform. The control system further determines processing location 270 that the destination container 260 is to be delivered to for further processing of at least one article in the container. Any known processing action can be performed at processing location 270. For example, the processing location can be configured for assembly of an item or order. In some embodiments, assembly can include grouping a plurality of items together to be shipped as a unit or as a single order. In some embodiments, assembly can include grouping together items that are to be shipped to a common location (e.g., zip code, city, or similar other attributes). An order or item can be manufactured or constructed into a final form during assembly (e.g., two portions of an order can be joined).

In some embodiments, processing location 270 can be configured for gift wrapping an order or article. Gift wrapping can include receiving and enclosing a gift in a decorative enclosure. In some embodiments, the gift wrapping can include covering the outside of the order or article in the decorative enclosure. In some embodiments, the gift wrapping can include packaging the order or article in a container (such as a box) and then gift wrapping the container. Gift wrapping can include the addition of a card or other element from the sender with a message, receipt, or a similar other piece of information. Gift wrapping at processing location 270 can be automated or semi-automated in some embodiments.

In some embodiments, processing location 270 can be configured to package an article or order. The term “package” as used herein refers to enclosing a particular article and/or order in a suitable container (e.g., box, envelope, padded mailer), such as for shipping. Packaging can further include the addition of filler materials to cushion the packaged item and prevent or eliminate damage. Suitable filler materials can include shipping peanuts, air cellular material, foam inserts, paper stuffing, paper shredding, and the like. In some embodiments, packaging can include the insertion of an order receipt, order form, return instructions, use instructions, packing list, and similar other attributes within the interior of the package to allow the receiver to ensure the entire order has been received. In some embodiments, packaging can include sealing the package, such as with tape, adhesive, and the like. Packaging at processing location 270 can be automated or semi-automated in some embodiments.

Processing location 270 can comprise labeling the order or article, such as after packaging has occurred. Suitable labeling can include information such as shipping data, return data, tracking number, date, shipping cost, and similar other attributes. In some embodiments, the labeling information can be printed directly onto the packaging, or it can be affixed to the package exterior. The labeling can be automated or semi-automated.

The control system as disclosed herein directs removal device 265 to remove destination container 260 from the position proximal to the platform 250 and transport it to the determined processing location. The disclosed system can include a plurality of processing locations 270. Alternatively, a single processing location can be configured to perform more than one task (e.g., packaging and labeling). The control system can be configured to direct a plurality of removal devices 265 such that there are no collisions. The control system can be further configured to determine when all of the articles required to complete at least one of the orders has been deposited into the destination container. The control system can send a notification that a particular order has been completed.

In some embodiments, the control system is further configured to indicate when the destination container is full or when the destination container is removed from its location so that the mobile transport device will not deliver articles to that location. The control system is further configured, and when an empty destination container is positioned proximal the platform, that the position can once again receive articles. The control system may be configured to indicate when the destination container is full or when the destination container has been removed whereby the control system directs a mobile transport device to cease delivery of articles to the removed destination container location. The control system is further configured to indicate when an empty destination container is positioned proximal to the platform whereby the control system directs the mobile transport device to resume delivery of articles to the empty destination container.

According to one embodiment, the control system is further configured to direct removal of the first destination container for shipment processing, and direct placement of a replacement destination container at a location of the removed first destination container; or direct removal of all articles in the first destination container for shipment processing and assign a third order to the first destination container. According to one embodiment, an order-removing equipment performs removal of the first destination container. According to one embodiment, the order-removing equipment comprises one or more of: a rail-based equipment, an autonomous mobile robot (AMR), an automated guided vehicle (AGV), a conveyorized device, and a self-propelled first destination container. According to one embodiment, the articles are pulled from an article storage area within an article sorting center, wherein the article sorting center is a distribution center, a retail store, a shipping center, or a micro fulfillment center.

According to one embodiment, the platform comprises a first panel and a second panel wherein the first panel is elevated compared to the second panel. According to one embodiment, the platform includes wheels to provide mobility. According to one embodiment, the plurality of destination containers includes wheels to provide mobility. According to one embodiment, the plurality of destination containers includes a self-propelling mechanism. According to one embodiment, each of the plurality of destination containers are positioned proximal an edge of the platform. According to one embodiment, the first computer-controlled mobile transport device traverses a platform proximal an opening in the platform, then manipulates from the first position to the second position to deposit the first and second articles into the destination container through the opening in the platform. According to one embodiment, each of the plurality of destination containers comprise one or more of: a tote, a carton, a bag, a shipping container, an accumulation device, and a chute. According to one embodiment, the control system is further configured to direct an automated deposition of the first and second articles onto the first computer-controlled mobile transport device.

According to one embodiment, the first and second articles are deposited onto the first computer-controlled mobile transport device manually. According to one embodiment, the first order further comprises a fifth article, the control system is further configured to update a status of the first order after deposition of the first and second articles in the first destination container but before the deposition of the fifth article in the first destination container. According to one embodiment, the control system is further configured to determine an identity of the fifth article before it is deposited in the first destination container to complete the first order. According to one embodiment, the control system is further configured to direct transport of the first destination container to a shipment processing location. According to one embodiment, the control system is further configured to assign a new order to the replacement destination container. According to one embodiment, the control system is further configured to direct one or more of: packaging, labelling, gift wrapping, quality control checking of the first order after it is completed.

As to the above, they are merely specific embodiments of the present invention; however, the scope of protection of the present invention is not limited thereto, and within the disclosed technical scope of the present invention, any modifications or substitutions that a person skilled in the art could readily conceive of should fall within the scope of protection of the present invention. Thus, the scope of protection of the present invention shall be determined by the scope of protection of the appended claims.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

These and other changes can be made to the disclosure in light of the Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

1. A system for sorting articles to one or more destinations, the system comprising:
an article supply location, wherein the article supply location includes a plurality of articles to be sorted;
a first computer-controlled mobile transport device having a first position in which an article is stowed about the device and a second position in which the article is deposited into a proximal destination container;
a platform elevated from a first surface, wherein the first computer-controlled mobile transport device traverses the platform and the stowed articles are deposited into a destination container positioned proximal the platform;
a control system configured to:
receive a first order for a plurality of disparate articles found within the article supply location;
assign a first destination container of a plurality of destination containers to the first order to direct the first computer-controlled mobile transport device to deposit a first article and a second article into the first destination container based on a product type of each article, the first and second articles selected from the plurality of disparate articles, wherein the first and second articles from the article supply location are both deposited at a same instant onto the first computer-controlled mobile transport device;
direct the first computer-controlled mobile transport device to transport and deposit both the first and second articles in the first destination container in a single trip by manipulation of the first computer-controlled mobile transport device from the first position to the second position;
determine the first order has been completed; and
direct removal of the first destination container.

2. The system of claim 1, wherein an order-removing equipment performs removal of the first destination container.

3. The system of claim 2, wherein the order-removing equipment comprises one or more of: a rail-based equipment, an autonomous mobile robot (AMR), an automated guided vehicle (AGV), a conveyorized device, and a self-propelled first destination container.

4. The system of claim 1, wherein the articles are pulled from an article storage location of an article sorting center, wherein the article sorting center comprises one or more of: a distribution center, a retail store, a shipping facility, or a micro fulfillment center.

5. The system of claim 1, wherein the platform comprises a first panel and a second panel wherein the first panel is elevated compared to the second panel.

6. The system of claim 1, wherein the platform includes wheels to provide mobility.

7. The system of claim 1, wherein the plurality of destination containers includes wheels to provide mobility.

8. The system of claim 1, wherein each of the plurality of destination containers are positioned proximal an edge of the platform.

9. The control system of claim 1, wherein the first computer-controlled mobile transport device traverses a platform proximal an opening in the platform, then manipulates from the first position to the second position to deposit the first and second articles into the destination container through the opening in the platform.

10. The system of claim 1, wherein each of the plurality of destination containers comprise one or more of a tote, a carton, a bag, a shipping container, an accumulation device, and a chute.

11. The system of claim 1, wherein the control system is further configured to direct an automated deposition of the first and second articles onto the first computer-controlled mobile transport device.

12. The system of claim 1, wherein the first and second articles are deposited onto the first computer-controlled mobile transport device manually.

13. The system of claim 1, wherein the first order further comprises a fifth article, wherein the control system is further configured to update a status of the first order after deposition of the first and second articles in the first destination container but before the deposition of the fifth article in the first destination container.

14. The system of claim 13, wherein the control system is further configured to determine an identity of the fifth article before it is deposited in the first destination container to complete the first order.

15. The system of claim 2, wherein the control system is further configured to direct transport of the first destination container to a shipment processing location.

16. The system of claim 1, wherein the control system is further configured to direct one or more of: packaging, labelling, gift wrapping, quality control checking of the first order after it is completed.

17. A system for sorting articles to one or more destinations, the system comprising:
an article supply location, wherein the article supply location includes a plurality of articles to be sorted;
a first computer-controlled mobile transport device having a first position in which an article is stowed about the device and a second position in which the article is deposited into a proximal destination container;
a platform elevated from a first surface, wherein the first computer-controlled mobile transport device traverses the platform and the stowed articles are deposited into a destination container positioned proximal the platform;
a control system configured to:
receive a first order for a plurality of disparate articles found within the article supply location;
assign a first destination container of a plurality of destination containers to the first order to direct the first computer-controlled mobile transport device to deposit a first article and a second article into the first destination container based on a product type of each article, the first and second articles selected from the plurality of disparate articles, wherein the first and second articles from the article supply location are both deposited at a same instant onto the first computer-controlled mobile transport device;
direct the first computer-controlled mobile transport device to transport and deposit both the first and second articles in the first destination container in a single trip by manipulation of the first computer-controlled mobile transport device from the first position to the second position;
determine the first order has been completed;
receive a second order for a plurality of disparate articles found within the article supply location;
assign a second destination container of the plurality of destination containers to the second order to direct a second computer-controlled mobile transport device to deposit a third article and a fourth article into the second destination container based on a product type of each article, the third and fourth articles selected from the plurality of disparate articles, wherein the third and fourth articles from the article supply location are both deposited at a same instant onto the second computer-controlled mobile transport device, wherein the second computer-controlled mobile transport device has a first position in which an article is stowed about the device and a second position in which the article is deposited into a proximal destination container, wherein the second computer-controlled mobile transport device traverses the platform;
direct the second computer-controlled mobile transport device to transport and deposit both the third and fourth articles in the second destination container in a single trip by manipulation of the second computer-controlled mobile transport device from the first position to the second position; and
determine the second order has been completed.

18. A system for sorting articles to one or more destinations, the system comprising:
an article supply location, wherein the article supply location includes a plurality of articles to be sorted;
a first computer-controlled mobile transport device having a first position in which an article is stowed about the device and a second position in which the article is deposited into a proximal destination container;
a platform elevated from a first surface, wherein the first computer-controlled mobile transport device traverses the platform and the stowed articles are deposited into a destination container positioned proximal the platform;
a control system configured to:
receive a first order for a plurality of disparate articles found within the article supply location;
assign a first destination container of a plurality of destination containers to the first order to direct the first computer-controlled mobile transport device to deposit a first article and a second article into the first destination container based on a product type of each article, the first and second articles selected from the plurality of disparate articles, wherein the first and second articles from the article supply location are both deposited at a same instant onto the first computer-controlled mobile transport device;
direct the first computer-controlled mobile transport device to transport and deposit both the first and second articles in the first destination container in a single trip by manipulation of the first computer-controlled mobile transport device from the first position to the second position;
determine the first order has been completed;
direct removal of the first destination container for shipment processing, and direct placement of a replacement destination container at a location of the removed first destination container; or
direct removal of all articles in the first destination container for shipment processing and assign a third order to the first destination container.

19. The system of claim 18, wherein the control system is further configured to assign a new order to the replacement destination container.

20. A control system configured for use with sorting of a plurality of disparate articles, the control system comprising a memory and a processor, the control system configured to:
receive a first order for a plurality of disparate articles found within an article supply location;
assign a first destination container of a plurality of destination containers to the first order to direct a first computer-controlled mobile transport device to deposit a first and a second article into the first destination container based on a product type of each article, the first and second articles selected from the plurality of disparate articles, wherein the first and second articles from the article supply location are both deposited at a same instant onto the first computer-controlled mobile transport device;
direct the first computer-controlled mobile transport device to transport and deposit both the first and second articles in the first destination container in a single trip by manipulation of the first computer-controlled mobile transport device from a first position to a second position; and
determine the first order has been completed.
